(19) United States
(12) Patent Application Publication
(10) Pub. No.: US 2008/0175536 A1
(43) Pub. Date: Jul. 24, 2008

(54) Two-Channel Multimode Rotary Joint

(75) Inventor: Nils Krumme, Feldafing (DE)

Correspondence Address: DAFFER MCDANIEL LLP, P.O. BOX 684908, AUSTIN, TX, 78768, US

(73) Assignee: SCHLEIFRING UND APPARATEBAU GMBH, Fuerstenfeldbruck (DE)

(21) Appl. No.: 12/017,739

(22) Filed: Jan. 22, 2008

(30) Foreign Application Priority Data
Jan. 24, 2007 (DE) 102007004517.6

(51) Int. Cl. G02B 6/26

(52) U.S. Cl. 385/25

(57) ABSTRACT

An optical two-channel rotary joint that is also suitable for coupling of single-mode fibers comprises two housing parts that are rotatable relative to each other. Each of these housing parts accommodates a light-waveguide for supplying light and a light-waveguide for withdrawing light. The arrangement has two optical paths adapted to operate in opposite directions, with each light-waveguide for supplying light being coupled with a light-waveguide for withdrawing light via an added biconvex lens. Furthermore, one focuser is disposed on each of the light-waveguides for supplying light, which focuses the light of the light-waveguide onto the corresponding light-waveguide for withdrawing light.

### PRIORITY CLAIM

The present application claims priority to pending German Application No. 102007004517.6 filed on Jan. 24, 2007.

### BACKGROUND OF THE INVENTION

1. Field of the Invention

The invention relates to a single-mode rotary joint for optical signals, having two channels, with which the signals can be simultaneously transmitted in opposite directions.

2. Description of the Prior Art

Because of their greater flexibility and robustness, optical bus systems are frequently used instead of cable-bound bus systems. With bus systems of this kind, signals or information are regularly transmitted in two opposite directions of the bus system, in order to make possible a bidirectional communication between different subscribers.

Optical rotary joints are known for transmission of optical signals between units that are rotatable relative to each other.

An optical rotary joint for a plurality of channels, having a Dove prism, is disclosed in U.S. Pat. No. 5,568,578. With a rotary joint of this kind, substantially more than two channels may be transmitted. It thus offers an excellent flexibility. However, the high costs of the elaborate mechanical arrangement render an optical joint of this kind of no interest for many applications.

A rotary joint having two channels is disclosed in U.S. Pat. No. 5,588,077. In all embodiments, one beam path (channel B) is widened by a pair of lenses, and then again narrowed, the optical elements of the other beam path (channel A) being disposed therein. Complex lens systems are needed with this device in which, in particular, a widening of the channel B must be effected to the extent that the optical elements of the channel A have an only insignificant effect. Furthermore, this device cannot be constructed to have rotational symmetry, because at least two light guides must be inserted into the beam path radially from the outside. This non-symmetry leads to an attenuation that is dependent upon an angle of rotation.

Another two-channel rotary joint is disclosed in DE 20018842. With this, light is coupled from a light-guiding fiber disposed to be inclined to the axis of rotation into another light-guiding fiber which is rotatable relative thereto and disposed on the rotation axis. Another corresponding coupling means is provided for the opposite beam path. A disadvantage of this arrangement is that the attenuation is very large with single-mode fibers.

### BRIEF SUMMARY OF THE INVENTION

The invention is based on the object of redesigning a rotary joint for bidirectional transmission of optical signals so that it will have a relatively low transmission loss which is substantially not dependent upon a rotation angle.

In accordance with the invention, the above object is achieved with an optical rotary joint, comprising: a first housing part and a second housing part connected to each other by means of a bearing unit to be rotatable about the rotation axis; a first optical path comprising a first light-waveguide on the first housing part for supplying light, and a second light-waveguide on the second housing part for withdrawing light; a second optical path extending in an opposite direction and comprising a third light-waveguide on the second housing part for supplying light, and a fourth light-waveguide on the first housing part for withdrawing the light; in which the second and fourth light-waveguides are disposed along the rotation axis, and the first and third light-waveguides light are disposed parallel to the rotation axis laterally of the rotation axis; wherein a lens is provided in the first optical path and in the second optical path; wherein a first focuser is provided at the end face of the first light-waveguide for focusing a light beam emitted from an end face of the first light-waveguide with the aid of the lens onto an end face of the second light-waveguide; and wherein a second focuser is provided at the end face of the third light-waveguide for focusing a light beam emitted from an end face of the third light-waveguide with the aid off the lens onto an end face of the fourth light-waveguide.

### BRIEF DESCRIPTION OF THE DRAWINGS

In the following the invention will be described by way of example without limitation of the general inventive concept on an example of embodiment and with reference to the drawings.

FIG. 1 schematically shows in a general form a rotary joint in accordance with the invention; and

FIG. 2 shows an example of a lens used in a rotary joint in accordance with the invention.

### DETAILED DESCRIPTION OF PREFERRED EMBODIMENTS

The optical rotary joint according to the invention comprises a first housing part 10 and also a second housing part 11 which are connected together to be rotatable about the rotation axis 14 by means of a bearing unit 12, 13. The first optical path comprises a first light-waveguide 20 on the first housing part 10 for supplying light, which is accommodated in the first ferrule 21. At the end of the light-waveguide there is provided a first focuser 22 for focusing the light 23 emitted by the light-waveguide onto the second light-waveguide 25 with the aid of a lens 15. The light-waveguide 25 on the second housing part 11 is itself accommodated in a ferrule 24. The second light path extending in the opposite direction comprises a third light-waveguide 30 on the second housing part 11 for supplying light, the third light-waveguide being accommodated in the ferrule 31. At the end of the third light-waveguide there is provided a second focuser 32 for focusing the light 33 emitted by the light-waveguide onto the fourth light-waveguide 35 with the aid of a lens 15. The light-waveguide 35 on the first housing part 10 is accommodated in the second ferrule 34.

With its basic principle, a rotary joint in accordance with the invention, having two channels, is suitable exclusively for signal transmission in one given direction. Thus, the first light path leads from the first light-waveguide 20 to the second light-waveguide 25. The second light path extends in the opposite direction from the third light-waveguide 30 to the fourth light-waveguide 35. With this, a transmission in two opposite directions is possible. This permits, exactly as with bus systems, communication needed in two directions, and also imposes no restriction on most of the conventional bus systems, because these use an own light-waveguide for each direction.

The term light-waveguides is used here in a general form. Preferably glass fibers, and most preferably single-mode fibers are used as light-waveguides. Alternatively, synthetic resin fibers can also be used as light-waveguides.

The term ferrules 21, 24, 31 and 34 is used here in a general sense for elements for supporting or guiding the light-waveguides. Alternatively, any desired elements having similar functions may be used. Alternatively, the light-waveguides could be also directly joined to the first housing part 10 or the second housing part 11.

The term lens relates to a preferably biconvex lens. Basically, lenses of other types are also suitable. Instead of a single lens, a lens system of two or more lenses would be also suitable. Basically, the lens may be any desired optical element that has rotational symmetry with respect to the rotation axis 14, and mirror symmetry with respect to a plane perpendicular to the rotation axis 14, and also deflects a beam traveling outside the rotation axis 14 but approximately parallel to this rotation axis, along the direction of the rotation axis. It is of importance that the lens have rotational symmetry with respect to the rotation axis 14, and mirror symmetry with respect to a plane passing perpendicularly through the rotation axis. The mirror symmetry makes it possible to achieve a symmetrical arrangement of the light-waveguides. If this mirror symmetry does not exist, then the distances of the light-waveguides from the middle of the rotary joint must be suitably adapted. An example of another lens having mirror symmetry is a body of two cones, preferably a double cone, in which the circular faces of both cones are adjacent. Alternatively, a GRIN lens could also be used. As only an edge region of the lens is used for the beam path, an inner region of the lens surrounding the rotation axis could be left open and provided with a bore.

The term focuser refers to any desired beam guiding and/or beam shaping element that is capable of imaging the light emitted by the first light-waveguide 20 or the third light-waveguide 30 onto the end face of the second light-waveguide 25 or the fourth light-waveguide 35, respectively. A focuser may be also a collimator. A particular advantage of the invention resides in only one single focuser being needed per channel, as distinct from prior art as known for example from U.S. Pat. No. 5,568,578. As these component parts are usually expensive and involve laborious adjustment, a substantial reduction of costs can be achieved with an embodiment such as that according to the invention.

A correct design of the focusers has a substantial effect on the coupling attenuation of the rotary joint. In the following, reference is made to the magnification factor of a focuser. Here the magnification factor is always considered together with the image of the lens. The magnification factor is defined here as the ratio of the beam diameter on the receiving side (e.g. end of the light-waveguide 20, or end of the light-waveguide 30) to the beam diameter on the entry side (e.g. end of the light-waveguide 25, or end of the light-waveguide 35).

In an ideal case, a magnification factor of 1 would offer a minimum of transmission loss, if the area of a light-waveguide on the entry side were to be identically imaged upon the area of a light-waveguide on the exit side. In fact, however, the mechanical tolerances of the entire arrangement must also be taken into account.

Advantageously the magnification factor of a focuser according to the invention is dimensioned so that it is smaller than 1, and thus all the light of the transmitting side is coupled onto the receiving side.

For particularly advantageous dimensioning, the magnification factor of a focuser in accordance with the invention is chosen so that the light spot diameter on the receiving side is smaller or equal to the diameter of the receiving light-waveguide minus the sum of all concentricity and eccentricity tolerances of the device, and preferably minus the lens aberrations.

An advantageous further development of the invention resides in an element for increasing the coupling efficiency being mounted in at least one light path directly in front of the end of a light-waveguide of the receiving side (20, 30). An element of this kind for increasing the coupling efficiency can be, for example, a fiber taper, a prism, or a ground fiber end, in particular also a ground end of a light-waveguide on the receiving side.

In another advantageous embodiment of the invention, the optical components of the two optical paths are displaced relative to each other. For this it is of importance that at least one light-waveguide for supplying light 20, 30, together with its assigned focuser 22, 32, be displaced relative to the light-waveguide for withdrawing light 35, 25, disposed on the same housing part 10, 11, along the direction of the corresponding light-waveguide for withdrawing light 25, 35. Thus, the end of at least one light-waveguide for supplying light and the end of the light-waveguide for withdrawing light, disposed on the same housing part, are not flush with each other. Thereby, in particular, the lengths of the optical paths can be reduced. Thus, the front edge of at least one focuser can be brought closer to the lens. As a result, not only the optical path, but also the constructional size of the entire arrangement can be shortened, because the longest building components (collimators plus focusers) are shifted into the inside of the rotary joint.

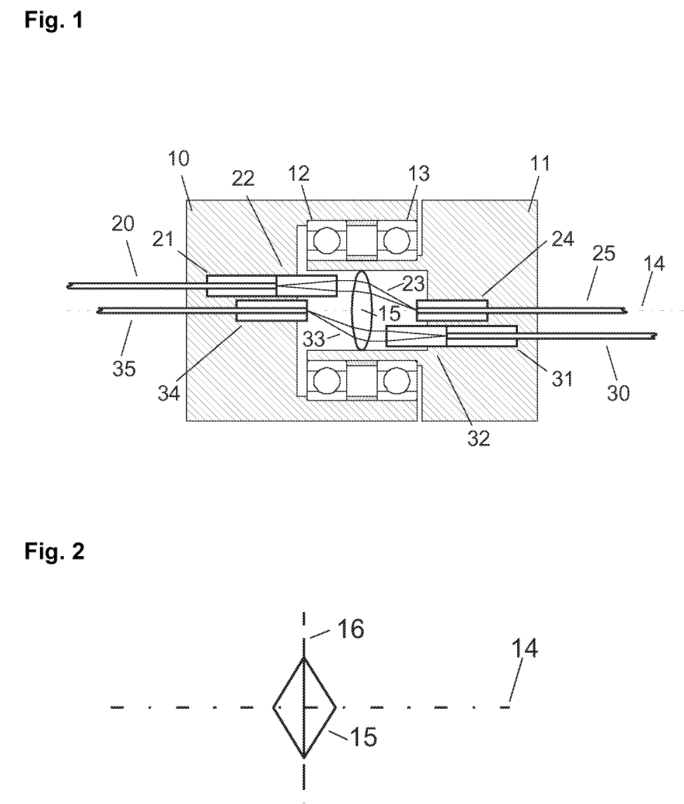

The optical rotary joint shown in FIG. 1 comprises a first housing part 10 and a second housing part 11 that are connected to each other by means of a bearing unit 12, 13 to be rotatable about the rotation axis 14. The bearing unit is here embodied using two ball bearings 12, 13, for example. Of course, in accordance with the inventive concept any other suitable bearing design would be possible. The first optical path comprises a first light-waveguide 20 on the first housing part 10 for supplying light, which is accommodated in the first ferrule 21. At the end of the light-waveguide there is provided a first focuser 22 for focusing the light 23 emitted by the light-waveguide onto the second light-waveguide 25. The light-waveguide 25 on the second housing part 11 is itself accommodated in a ferrule 24. The second light path extending in the opposite direction comprises a third light-waveguide 30 on the second housing part 11 for supplying light, the third light-waveguide being accommodated in the ferrule 31. At the end of the third light-waveguide there is provided a second focuser 32 for focusing the light 33 emitted by the light-waveguide onto the fourth light-waveguide 35. The light-waveguide 35 on the first housing part 10 is accommodated in the second ferrule 34. A lens 15 is additionally provided in both beam parts. This ensures a deflection of light issuing parallel to the rotation axis from a light-supplying light-waveguide along the direction of the rotation axis, so that preferably it is incident at the middle of the corresponding light-withdrawing light-waveguide. The light-waveguides 25 and 35 are disposed along the rotation axis 14.

In this embodiment, the components of the first and second optical paths are displaced relative to each other in order to reduce the optical path length and the entire constructional size of the arrangement.

A special embodiment of the lens 15, as shown in FIG. 2, consists of two conically shaped parts disposed with rotational symmetry with respect to the rotation axis 14. The two conically shaped parts are joined to each other at their flat sides (circular faces). The entire arrangement has mirror symmetry with respect to a plane 16 perpendicular to the rotation axis 14.

1. Optical rotary joint, comprising:
a first housing part and a second housing part connected to each other by means of a bearing unit to be rotatable about the rotation axis;
a first optical path comprising a first light-waveguide on the first housing part for supplying light, and a second light-waveguide on the second housing part for withdrawing light;
a second optical path extending in an opposite direction and comprising a third light-waveguide on the second housing part for supplying light, and a fourth light-waveguide on the first housing part for withdrawing the light;
in which the second and fourth light-waveguides are disposed along the rotation axis, and the first and third light-waveguides light are disposed parallel to the rotation axis laterally of the rotation axis;
wherein a lens is provided in the first optical path and in the second optical path;
wherein a first focuser is provided at the end face of the first light-waveguide for focusing a light beam emitted from an end face of the first light-waveguide with the aid of the lens onto an end face of the second light-waveguide; and
wherein a second focuser is provided at the end face of the third light-waveguide for focusing a light beam emitted from an end face of the third light-waveguide with the aid off the lens onto an end face of the fourth light-waveguide.

2. Optical rotary joint according to claim 1, wherein the lens is a biconvex lens.

3. Optical rotary joint according to claim 1, wherein the lens is a body having rotational symmetry with respect to the rotation axis and has the shape of two cones joined together at their base sides.

4. Optical rotary joint according to claim 1, wherein at least one of the light-waveguides is fixed in a ferrule.

5. Optical rotary joint according to claim 1, wherein a magnification of at least one focuser together with the lens is less than 1.

6. Optical rotary joint according to claim 1, wherein a magnification of at least one focuser is such that a light spot formed on the end face of a light-waveguide for withdrawing light has a diameter that is less than or equal to a diameter of the light-waveguide for withdrawing light guide minus a sum of all concentricity and eccentricity tolerances of the rotary joint.

7. Optical rotary joint according to claim 1, wherein an element for increasing coupling efficiency is disposed in the light path in front of at least one of the light guides for withdrawing light.

8. Optical rotary joint according to claim 7, wherein the element for increasing coupling efficiency is one of a fiber taper or a prism.

9. Optical rotary joint according to claim 1, wherein at least one end of one of the light guides for withdrawing light is ground.

10. Optical rotary joint according to claim 1, wherein at least one light-waveguide for supplying light, together with its focuser, is displaced parallel to the rotation axis relative to the light-waveguide for withdrawing light disposed on a same housing part, along a direction of the light-waveguide for withdrawing light.
